(19) United States
(12) Patent Application Publication
(10) Pub. No.: US 2018/0092055 A1
(43) Pub. Date: Mar. 29, 2018

(54) SYNCHRONIZED AND UNSYNCHRONIZED PHASES FOR SECTORIZED ANTENNAS

(71) Applicant: Intel IP Corporation, Santa Clara, CA (US)

(72) Inventors: LAURENT CARIOU, PORTLAND, OR (US); CARLOS CORDEIRO, PORTLAND, OR (US); OU YANG, SANTA CLARA, CA (US); CHITTABRATA GHOSH, FREMONT, CA (US)

(21) Appl. No.: 15/277,238

(22) Filed: Sep. 27, 2016

(51) Int. Cl. H04W 56/00; H04B 7/04

(52) U.S. Cl. CPC H04W 56/0005; H04B 7/0452

(57) ABSTRACT

This disclosure describes systems, methods, and devices related to allocating synchronized and unsynchronized time periods in multiuser multiple-input and multiple-output (MU-MIMO) communications. A device may determine a first portion and a second portion of a beacon interval. The device may determine the first portion to comprise one or more first service periods associated with one or more first devices. The device may determine the second portion to comprise one or more second service periods associated with one or more second devices. The device may cause to send one or more first frames to at least one of the first devices during the one or more first service periods. The device may cause to send one or more second frames to at least one of the second devices during the one or more second service periods.

### TECHNICAL FIELD

This disclosure generally relates to systems and methods for wireless communications and, more particularly, to multiuser multiple-input and multiple-output (MU-MIMO) scheduling for synchronized and unsynchronized time periods allocation.

### BACKGROUND

Wireless devices are becoming widely prevalent and are increasingly requesting access to wireless channels. A wireless communication network in a millimeter-wave band may provide high-speed data access for users of wireless communication devices. Beamforming represents techniques that can be used for enhancing throughput and range in wireless networks including, but not limited to, the next generation 60 GHz (NG60) network.

### BRIEF DESCRIPTION OF THE DRAWINGS

FIG. 1 depicts a network diagram illustrating an example network environment for antenna adjustment for MU-MIMO synchronized and unsynchronized time periods allocation, in accordance with one or more example embodiments of the present disclosure.

FIG. 2 depicts an illustrative schematic diagram for sectored antennas in MU-MIMO communications, in accordance with one or more example embodiments of the present disclosure.

FIG. 3 depicts an illustrative schematic diagram for MU-MIMO synchronized and unsynchronized time periods allocation, in accordance with one or more example embodiments of the present disclosure.

FIG. 4 depicts an illustrative schematic diagram for MU-MIMO synchronized and unsynchronized time periods allocation, in accordance with one or more example embodiments of the present disclosure.

FIG. 5A depicts a flow diagram of an illustrative process for MU-MIMO synchronized and unsynchronized time periods allocation, in accordance with one or more example embodiments of the present disclosure.

FIG. 5B depicts a flow diagram of an illustrative process for MU-MIMO synchronized and unsynchronized time periods allocation, in accordance with one or more example embodiments of the present disclosure.

FIG. 6 illustrates a functional diagram of an example communication station that may be suitable for use as a user device, in accordance with one or more example embodiments of the present disclosure.

FIG. 7 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices for allocating synchronized and unsynchronized time periods in MU-MIMO communications.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Devices may communicate with each other by sending and receiving one or more frames between each other. These frames may include one or more fields (or symbols) that may be based on IEEE 802.11 specifications, including, but not limited to, an IEEE 802.11ad specification or an IEEE 802.11ay specification. In some IEEE 802.11 specifications, devices may operate in accordance with multiuser (MU) multiple-input and multiple-output (MIMO) technology. MIMO facilitates multiplying the capacity of a radio link using multiple transmit and receive antennas to exploit multipath propagation. MIMO provides a practical technique for sending and receiving more than one data signal on the same radio channel at the same time via multipath propagation. MU-MIMO provides a way for wireless devices to communicate with each other using multiple antennas such that the wireless devices may transmit at the same time and frequency and still be separated by their spatial signatures. For example, using MU-MIMO, an access point (AP) may be able to communicate with multiple devices using multiple antennas at the same time to send and receive data. An AP operating in MU-MIMO and in a 60 GHz frequency band may utilize an MU-MIMO frame to communicate with devices serviced by that AP. Enhancements beyond the new 60 GHz PHY include personal basic service set (PBSS) operation, directional medium access, and beamforming. PBSS retains existing infrastructure and independent BSS network architectures, with channel access being enhanced to support directionality and spatial reuse, including both random and scheduled access.

To increase or widen the coverage area such that the number of served devices is maximized, multiple sector antennas may be configured on a device (e.g., AP and/or STAs). The multiple sector antennas may allow, for example, an AP to serve devices based on the number of sectors that may be covered by each antenna of the AP. For example, an AP, with three antennas having each a 120-degree sector, may provide coverage around the AP such that the devices located around the AP may be served by the AP.

In some instances, the AP may communicate with devices in a synchronized or unsynchronized MU-MIMO operation. In a synchronized MU-MIMO operation, the AP may simultaneously transmit to multiple devices using a frame that starts and ends at the same time. In an unsynchronized MU-MIMO operation, the AP may facilitate point-to-multipoint simultaneous transmissions between the AP and multiple devices, where each device is addressed separately by the AP.

Typically, an AP is incapable of indicating whether it is operating in a synchronized or unsynchronized way. One reason may be that the AP is unable to divide a beacon interval into different time periods that may be associated with synchronized or unsynchronized modes of operation.

Example embodiments of the present disclosure relate to systems, methods, and devices for allocating synchronized and unsynchronized time periods in MU-MIMO communications.

In some demonstrative embodiments, one or more devices may be configured to communicate an MU-MIMO frame, for example, over a 60 GHz frequency band. The one or more devices may be configured to communicate in a mixed environment such that one or more legacy devices are able to communicate with one or more non-legacy devices. That is, devices following one or more IEEE 802.11 specifications may communicate with each other regardless of which IEEE 802.11 specification is followed.

Directional multi-gigabyte (DMG) communications may involve one or more directional links to communicate at a rate of multiple gigabits per second, for example, at least 1 gigabit per second, 7 gigabits per second, or any other rate. An amendment to a DMG operation in a 60 GHz band, e.g., according to an IEEE 802.11ad standard, may be defined, for example, by an IEEE 802.11ay project.

In some demonstrative embodiments, one or more devices may be configured to communicate over a next generation 60 GHz (NG60) network, an extended DMG (EDMG) network, and/or any other network. For example, the one or more devices may be configured to communicate over the NG60 or EDMG networks.

In one embodiment, an unsynchronized MU-MIMO system may enable directionality of one or more antennas. That is, a transmission link between an antenna from the AP and one station (STA) may be established independently with respect to another link from another antenna from the AP and another STA. This may enable the AP to perform scheduling and interference coordination between one or more STAs using different sectors associated with the one or more antennas.

In one embodiment, an MU-MIMO synchronized and unsynchronized time periods allocation system may facilitate a mode of operation for an AP to define time phases for synchronized operation (where all antennas are synchronized) and time phases for unsynchronized operation. The MU-MIMO synchronized and unsynchronized time periods allocation system may also allocate one or more devices to specific antennas, during unsynchronized phases.

In one embodiment, the MU-MIMO synchronized and unsynchronized time periods allocation system may define the behavior of one or more devices in the different phases. For example, in the synchronized phase, the MU-MIMO synchronized and unsynchronized time periods allocation system may define which frames may be sent, which antennas to use, what beamforming configuration to use, and how to perform beamforming training. In the unsynchronized phase, the MU-MIMO synchronized and unsynchronized time periods allocation system may define which frames may be sent, which AP antenna/sector ID to connect to, and which beamforming configurations to use, and how to perform beamforming training.

The above descriptions are for purposes of illustration and are not meant to be limiting. Numerous other examples, configurations, processes, etc., may exist, some of which are described in greater detail below. Example embodiments will now be described with reference to the accompanying figures.

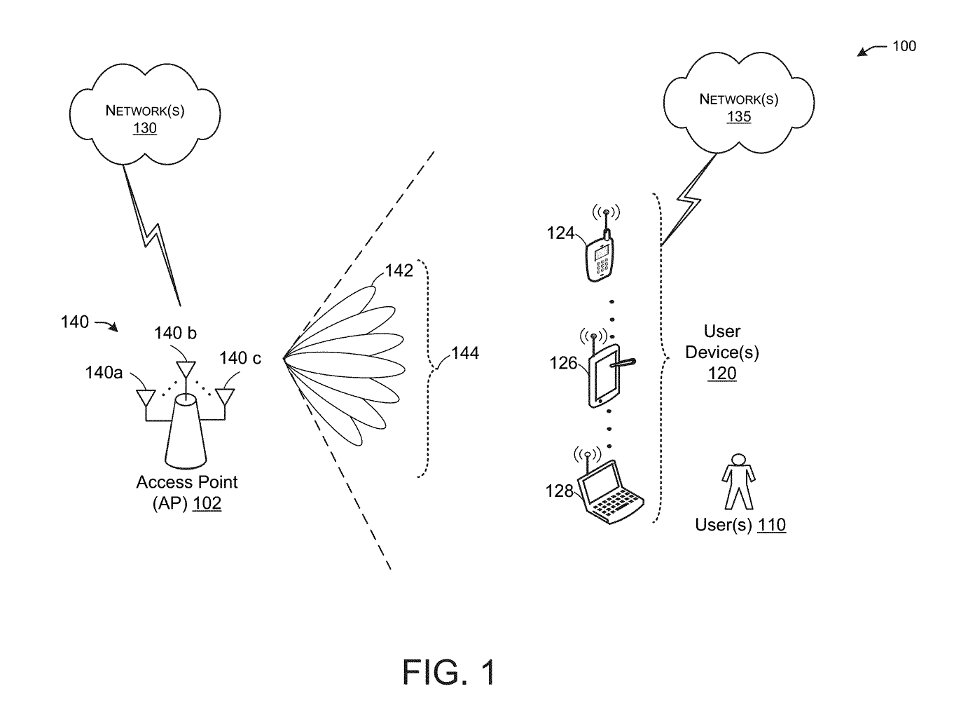

FIG. 1 is a network diagram illustrating an example network environment for antenna adjustment for an MU-MIMO synchronized and unsynchronized time periods allocation system, according to some example embodiments of the present disclosure. Wireless network 100 may include one or more user device(s) 120 and one or more access point(s) (AP) 102, which may communicate in accordance with IEEE 802.11 communication standards, such as the IEEE 802.11ad and/or IEEE 802.11ay specifications. The user device(s) 120 may be mobile devices that are non-stationary and do not have fixed locations.

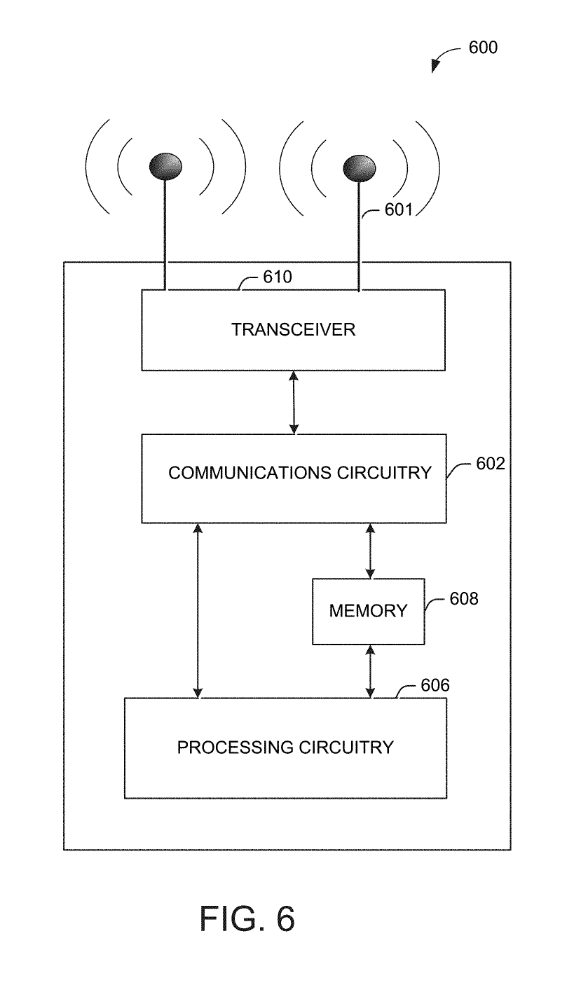

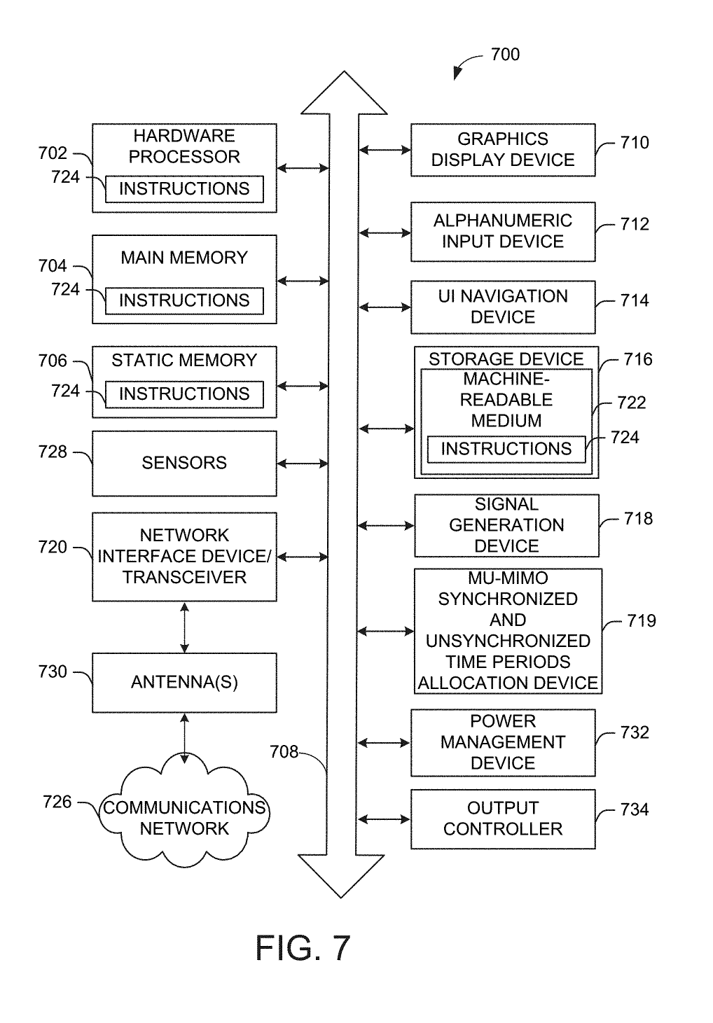

In some embodiments, the user device(s) 120 and the AP 102 may include one or more computer systems similar to that of the functional diagram of FIG. 6 and/or the example machine/system of FIG. 7.

One or more illustrative user device(s) 120 and/or the AP 102 may be operable by one or more user(s) 110. The user device(s) 120 (e.g., 124, 126, or 128) and/or the AP 102 may include any suitable processor-driven device including, but not limited to, a mobile device or a non-mobile, e.g., a static, device. For example, the user device(s) 120 and/or the AP 102 may include a user equipment (UE), a station (STA), an access point, a personal basic service set (PBSS) control point, a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like.

Any of the user device(s) 120 (e.g., user devices 124, 126, 128), and the AP 102 may be configured to communicate with each other via one or more communications networks 130 and/or 135 wirelessly or wired. Any of the communications networks 130 and/or 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and the AP 102 may include one or more communications antennas 140. The one or more communications antennas 140 may be any suitable type of antennas corresponding to the communications protocols used by the user device(s) 120 (e.g., user devices 124, 126 and 128), and the AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or the AP 102.

Any of the user device(s) 120 (e.g., user devices 124, 126, 128), and the AP 102 may be configured to perform directional transmission and/or directional reception in conjunction with wirelessly communicating in a wireless network. Any of the user device(s) 120 (e.g., user devices 124, 126, 128), and the AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and the AP 102 may be configured to perform any given directional transmission towards one or more defined transmit sectors. Any of the user device(s) 120 (e.g., user devices 124, 126, 128), and the AP 102 may be configured to perform any given directional reception from one or more defined receive sectors.

MIMO beamforming in a wireless network may be accomplished using RF beamforming and/or digital beamforming. In some embodiments, in performing a given MIMO transmission, the user devices 120 and/or the AP 102 may be configured to use all or a subset of its one or more communications antennas to perform MIMO beamforming.

Any of the user devices 120 (e.g., user devices 124, 126, 128), and the AP 102 may include any suitable radio and/or transceiver for transmitting and/or receiving radio frequency (RF) signals in the bandwidth and/or channels corresponding to the communications protocols utilized by any of the user device(s) 120 and the AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHz channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

Some demonstrative embodiments may be used in conjunction with a wireless communication network communicating over a frequency band of 60 GHz. However, other embodiments may be implemented utilizing any other suitable wireless communication frequency bands, for example, an extremely high frequency (EHF) band (the millimeter wave (mmWave) frequency band), a frequency band within the frequency band of between 20 GHz and 300 GHz, a WLAN frequency band, a WPAN frequency band, a frequency band according to the WGA specification, and the like.

An antenna for a radio transmitter converts signals into electromagnetic waves to be transmitted to a receiving device. Any antenna that transmits can also receive. A transmitting antenna may generate stronger electromagnetic waves in some directions than other antennas. The antenna may radiate waves of a different amplitude and phase, and each of these waves travels a different distance to the point where a receiving device is located. In some directions, these waves add constructively to give a gain. In some directions, these waves cause interference and a loss of gain. An omnidirectional antenna may be an antenna that has a non-directional pattern (circular pattern) in a given plane with a directional pattern in any orthogonal plane. An omnidirectional antenna may have a wider angle to allow communication with multiple devices.

In communications, beamforming is used to point an antenna at the signal source to reduce interference and improve communication quality. In direction finding applications, beamforming can be used to steer an antenna to determine the direction of the signal source.

The direction of beams may be controlled by varying the angle of the beam pattern, by modifying the orientation of the antenna, or by polarization. In beamforming, both the amplitude and phase of each antenna element may be controlled. Combined amplitude and phase control may be used to adjust various wave levels and directions. The beams may be arranged in a beam pattern that may be defined by an angle that determines the area that the beams may be directed to. For example, the beams of one antenna may have a beam pattern associated with an angle of 120 degrees, 90 degrees, 60 degrees, etc. The angle may be considered an antenna sector. The angle may be varied in order to increase or decrease the area covered by the beam pattern and hence change the antenna sector. For example, increasing the angle may increase the area of a beam pattern and lowering the angle may decrease the area of a beam pattern.

The phrases “directional multi-gigabit (DMG)” and “directional band (DBand),” as used herein, may relate to a frequency band wherein the channel starting frequency is above 45 GHz. In one example, DMG communications may involve one or more directional links to communicate at a rate of multiple gigabits per second, for example, at least 1 gigabit per second, 7 gigabits per second, or any other rate.

In some demonstrative embodiments, the user device(s) 120 and/or the AP 102 may be configured to operate in accordance with one or more specifications, including one or more IEEE 802.11 specifications, (e.g., an IEEE 802.11ad specification, an IEEE 802.11ay specification, and/or any other specification and/or protocol). For example, an amendment to a DMG operation in the 60 GHz band, according to an IEEE 802.11ad standard, may be defined, for example, by an IEEE 802.11ay project.

Some specifications (e.g., an IEEE 802.11ad specification) may be configured to support a single user (SU) system, in which a station (STA) cannot transmit frames to more than a single STA at a time. Such specifications may not be able to support an STA transmitting to multiple STAs simultaneously, using a multi-user (MU) MIMO (MU-MIMO) scheme (e.g., a downlink (DL) MU-MIMO), or any other MU scheme.

In some demonstrative embodiments, the user device(s) 120 and/or the AP 102 may be configured to implement one or more MU mechanisms. For example, the user device(s) 120 and/or the AP 102 may be configured to implement one or more MU mechanisms, which may be configured to enable MU communication of downlink (DL) frames using a multiple-input and multiple-output (MIMO) scheme between a device (e.g., AP 102) and a plurality of user devices, including the user device(s) 120 and/or one or more other devices.

In some demonstrative embodiments, the user devices 120 and/or the AP 102 may be configured to communicate over a next generation 60 GHz (NG60) network, an extended DMG (EDMG) network, and/or any other network. For example, the user devices 120 and/or the AP 102 may be configured to communicate MIMO transmissions (e.g., DL MU-MIMO) and/or use channel bonding for communicating over the NG60 and/or EDMG networks.

In some demonstrative embodiments, the user devices 120 and/or the AP 102 may be configured to support one or more mechanisms and/or features (e.g., channel bonding, single user (SU) MIMO, and/or multiuser (MU) MIMO) in accordance with an EDMG standard, an IEEE 802.11ay standard, and/or any other standard and/or protocol.

In order for an AP (e.g., AP 102) to establish communication with one or more user device(s) 120 (e.g., user devices 124, 126, and/or 128), the AP 102 may communicate in a downlink direction, and the user device(s) 120 may communicate with the AP 102 in an uplink direction by sending frames in either direction. The frames may include one or more training fields that may be used for channel estimation, channel training, channel characterization, and other functions needed for establishing a channel between a transmitting device, such as an AP 102, and a receiving device, such as a user device 120.

Beamforming of beams on an antenna utilizes the training fields in order to enhance the formation of beams. These training fields may be communicated between devices (e.g., the AP 102 and/or the user device(s)s 120). Beamforming depends on channel calibration procedures, called channel sounding, to determine how to radiate energy in a preferred direction. Many factors may influence how to steer a beam in a particular direction. Beamforming enables the endpoints at either side of a link to get maximum performance by taking advantage of channels that have strong performance while avoiding paths and carriers that have weak performance.

In one embodiment, and with reference to FIG. 1, a device (e.g., the user device(s) 120 and/or the AP 102) may be configured to communicate an MU-MIMO frame, for example, over a 60 GHz frequency band. For example, the AP 102 may contain one or more antenna(s) 140 that may be comprised of antennas 140a, 140b, and 140c. It should be noted that although FIG. 1 shows AP 102 having three antennas, the AP 102 may have more or less antennas based on the application. Each of the antennas 140a, 140b, and 140c may generate one or more beams 142 that may be directed towards one or more user devices 120. The beams may be arranged in a beam pattern 144 that is based at least in part on the direction of communication. Typically, beamforming may be accomplished physically (shaping and moving a transducer), electrically (analog delay circuitry), or mathematically (digital signal processing).

The beam pattern 144 may be pointed in a direction of communication with at least one of the user devices 120. The beam pattern 144 may be depicted by a sector angle and by a direction. That is the beam pattern 144 may have an area that may be defined by the angle spanning over the beams and by the direction of communication with at least one of the user devices 120.

In one embodiment, the AP 102 may define the behavior of one or more devices in the different portions of a time domain. The AP 102 may allocate a portion of the time domain to be dedicated for synchronized MU-MIMO operation with the user devices 120. In a synchronized MU-MIMO operation, the AP 102 may simultaneously transmit using its antennas to multiple devices in a frame that starts and ends at the same time. That is, the AP 102 transmits on all antennas simultaneously each time the AP 102 wants to communicate with the user devices 120. For example, in the synchronized phase, the AP 102 may define which frames may be sent, which antennas to use, what beamforming configuration to use, and how to perform beamforming training.

In another embodiment, the AP may allocate a different portion of the time domain to be dedicated for unsynchronized MU-MIMO operation with the user devices 120. In an unsynchronized MU-MIMO operation, the AP 102 may facilitate point-to-multipoint transmissions between the AP and multiple devices, where each device is addressed separately by the AP. That is, the AP 102 may be able to transmit using each of its antennas to communicate with one or more user devices independent of each other. For example, the AP 102 may be able to communicate with user device 124 using a first antenna and user device 126 using a second antenna, such that the communication with user device 124 is independent or unsynchronized with the communication with user device 126. In the unsynchronized phase, the AP 102 may define which frames may be sent, which AP antenna/sector ID to connect to, and which beamforming configurations to use, and how to perform beamforming training.

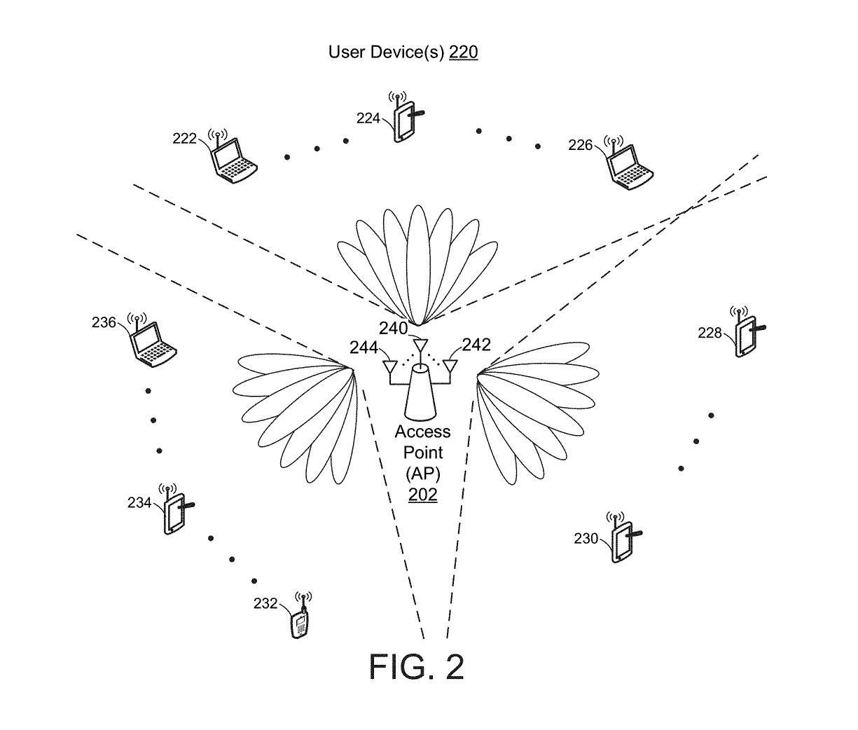

FIG. 2 depicts an illustrative schematic diagram for sectored antennas in MU-MIMO communications, in accordance with one or more example embodiments of the present disclosure.

As shown in FIG. 2, an AP 202 and user devices 220 (i.e., user devices 222, 224, 226, 228, 230, 232, 234, and 236 may be in communication with each other. The AP 202 may include one or more antennas (e.g., antennas 240, 242, and 244). These antennas may be directed to various sectors, and each sectored antenna may serve one or more user devices 220. Antennas 240, 242, and 244 may be arranged in such a way to cover the majority of the areas that are surrounding the AP 202. This is meant to maximize the coverage of the AP 202 by servicing as many user devices 220 as possible. In this example, by orienting the three antennas to cover various areas around the AP 202, the devices located around the AP 202 may be able to communicate using electromagnetic waves between the antennas of the user devices 220 and the antennas of the AP 202. For example, a first group of user devices 220 (e.g., user devices 222, 224, and 226) may be serviced by the antenna 240. A second group of user devices 220 (e.g., user devices 228 and 230) may be serviced by the antenna 242, and a third group of user devices 220 (e.g., user devices 232, 234, and 236) may be serviced by the antenna 244. In that sense, these devices may be located in the sector, or the beam pattern area, of the respective antenna. Additionally, polarization may play a role in determining which user device 220 communicates with which antenna of the AP 202.

Referring to FIG. 2, the AP 202 may comprise multiple sectors of antennas that may operate in a synchronized or unsynchronized way. In a synchronized operation, the sectored antennas are complementary to enable quasi-omni coverage. Further, each antenna may have its own baseband processing and its own media access control (MAC) enhanced distributed channel access (EDCA). It is understood that EDCA is a channel access method, where high-priority traffic has a higher chance of being sent than low-priority traffic. A station with high priority traffic may wait a little less before it sends its packet, on average, than a station with low priority traffic. The levels of priority in EDCA are called access categories (ACs). In addition, EDCA provides contention-free access to the channel for a period called a transmit opportunity (TXOP). In the synchronized operation, all antennas may be used in a synchronized way such that the AP may simultaneously transmit using its antennas to multiple devices in a frame that starts and ends at the same time.

In the unsynchronized operation, each antenna may be fully independent from the other antennas, such that an antenna may transmit or receive signals without any time synchronization with other antennas. For example, one antenna that may transmit signals while other antennas may receive signals.

The above descriptions are for purposes of illustration and are not meant to be limiting.

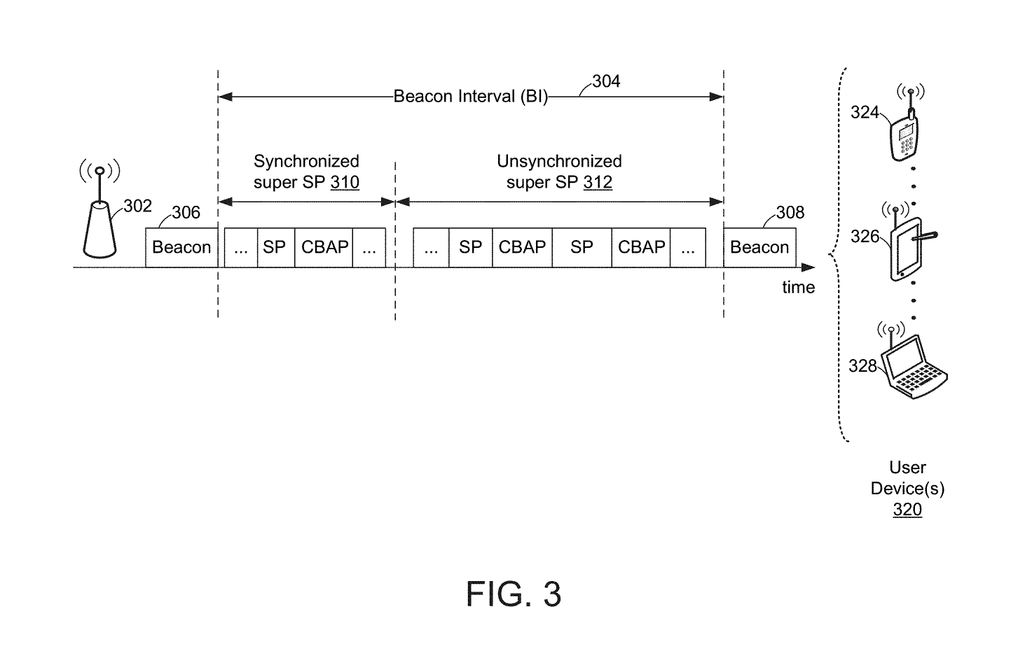

FIG. 3 depicts an illustrative schematic diagram for MU-MIMO synchronized and unsynchronized time periods allocation, in accordance with one or more example embodiments of the present disclosure.

In one embodiment, the MU-MIMO synchronized and unsynchronized time periods allocation system may facilitate time phase definition such that a first portion of a time domain is allocated for synchronized operations and a second portion of the time domain is allocated for unsynchronized operations. An AP may use the extended schedule element to schedule SPs for communication between source and destination DMG STAs. Typically, the extended schedule element is included in a beacon frame. A DMG STA may be identified by the destination association identifier (AID) field contained in a grant frame or extended schedule element used for the allocation of an SP or a contention based access period (CBAP). An SP or CBAP allocation within an extended schedule element may comprise one or more individual allocations associated with one or more DMG STAs. An SP (or CBAP) is a contiguous time period for which an STA is capable of data transfer. During the CBAP, multiple STAs may contend for channel access in order to transmit their data. A beacon interval (BI) may be a time interval that may be between consecutive beacon frames. Within each BI, one or more SPs and/or one or more CBAPs may be allocated.

Referring to FIG. 3, there is shown an AP 302 communicating with one or more DMG STAs (e.g., user devices 320). The AP 302 may send one or more beacon frames (e.g., beacon frame 306 and beacon frame 308) to user devices 324, 326, and/or 328. A beacon interval 304 may be determined between the beacon frame 306 and the beacon frame 308.

In one embodiment, the AP 302 may define two or more super SPs. The two or more super SPs may be comprised of one or more synchronized super SPs (e.g., synchronized super SP 310) and one for unsynchronized super SPs (e.g., unsynchronized super SP 312). Each of these super SPs may then be separated into one or more SPs or CBAPs based on the extended schedule element. It should be noted that in each of these super SPs (e.g., synchronized super SP 310 and unsynchronized super SP 312), the SP and CBAP allocation may determine the way the DMG STAs (e.g., user devices 320) may access the channel.

In one embodiment, the AP 302 may advertise the super SPs (e.g., synchronized super SP 310 and unsynchronized super SP 312) in the beacons (e.g., beacon frames 306 and 308) and the announce frames. An announce frame may be transmitted during the announcement time interval (ATI) of a beacon interval. The ATI may be used to convey control and management information, such as association, scheduling, or other control and management information, between the AP and the STAs. The announce frame may perform functions including that of a DMG beacon frame.

In one embodiment, when the user device 326 receives the beacon frame 306, the user device 326 may decode or extract from the beacon frame 306 one or more information elements associated with the super SPs within the BI 304. The one or more information elements may include an extended schedule element that may include characteristics associated with the super SPs. Some of the characteristics may include whether a super SP is a synchronized super SP (e.g., synchronized super SP 310) or an unsynchronized super SP (e.g., unsynchronized super SP 312). That is, the AP 302 may utilize the extended schedule element, by setting one or more reserve bits to indicate whether the SP is a super SP or not, and whether the super SP is synchronized or unsynchronized. In some embodiments, the AP 302 may define a new extended schedule element instead of utilizing the existing extended schedule element. For example, the new extended schedule element may be included in a beacon frame (e.g., beacon 306 and beacon 308) sent from the AP 302 to the user devices 320.

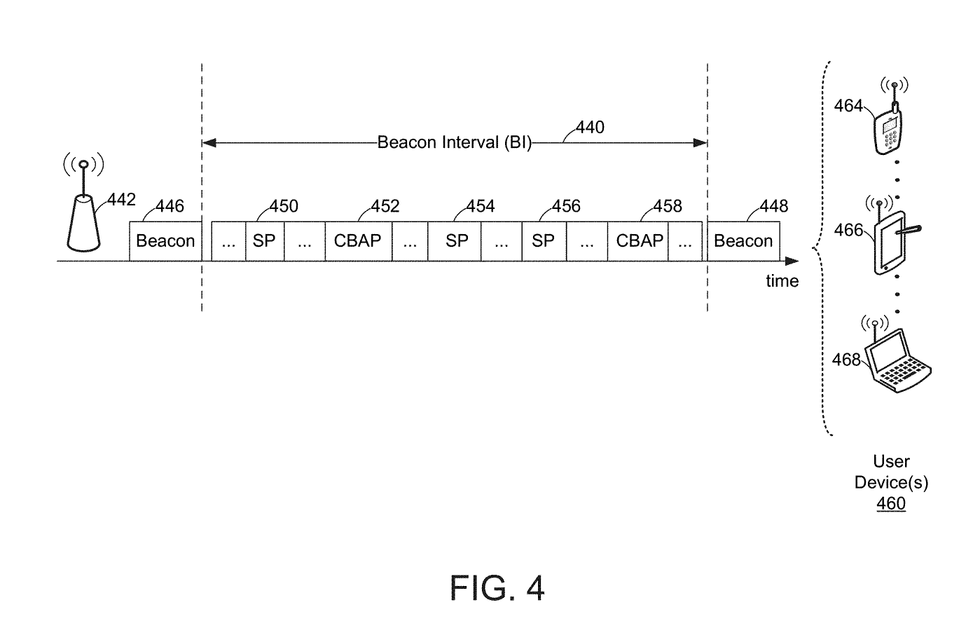

FIG. 4 depicts a flow diagram of an illustrative process for MU-MIMO synchronized and unsynchronized time periods allocation, in accordance with one or more example embodiments of the present disclosure.

In one embodiment, an MU-MIMO synchronized and unsynchronized time periods allocation system may facilitate the allocation of SPs and CBAPs (e.g., SP 450, CBAP 452, SP 454, SP 456, CBAP 458) within a BI (e.g., BI 440 between beacon frame 446 and beacon frame 448) by an AP 442 to be used in synchronized or unsynchronized operations instead of defining super SPs as explained above in FIG. 3. This may be accomplished by defining one or more fields in the extended schedule element to indicate whether the SPs and/or CBAPs are for synchronized or unsynchronized operations. For example, the MU-MIMO synchronized and unsynchronized time periods allocation system may encode one or more fields in the extended schedule element to indicate that SP 450, CBAP 452, and SP 456 are to be associated with synchronized operations, and SP 454 and CBAP 458 are to be associated with unsynchronized operations. In that case, AP 442 may send the beacon 446 to one or more user devices 460 (e.g., user devices 464, 466, and 468). The one or more user devices 460 may decode the beacon 446 and extract the extended schedule element from the beacon 446. The one or more user devices 460 may then decode or otherwise extract one or more fields included in the extended schedule element. The one or more fields may indicate the SP and/or CBAP allocations. Further, the one or more fields may indicate which SPs and CBAPs are allocated for synchronized operation or unsynchronized operation.

In one embodiment, the one or more fields may also indicate which antennas may be used in the SPs and the CBAPs. For example, the MU-MIMO synchronized and unsynchronized time periods allocation system may determine the extended schedule to contain information associated with the identity of antennas to be used between the AP 442 and the STAs. For example, the AP 442 may assign a first set of antenna IDs to be used for synchronized operations and a second set of antenna IDs to be used for unsynchronized operations.

In one embodiment, the MU-MIMO synchronized and unsynchronized time periods allocation system may determine that when an AP is communicating with one or more user devices, one or more message types may be used in a synchronized operation and other message types may be used in an unsynchronized operation. For example, the AP 442 may determine that management messages (e.g., authentication, control, association messages) may be sent and received during synchronized access periods (e.g., SPs and/or CBAPs) and that user data transmissions may be sent and received during unsynchronized access periods. For example, the AP 442 may define that SP 450, CBAP 452, and SP 456 are associated with synchronized operations. In addition, the AP 442 may define that SP 454 and CBAP 458 are associated with unsynchronized operations. The AP 442 may send and receive messages associated with management type messages during SP 450, CBAP 452, and SP 456, and may send and receive messages associated with user data transmissions during SP 454 and CBAP 458 or vice versa.

In one embodiment, the MU-MIMO synchronized and unsynchronized time periods allocation system may define a group ID (e.g., a multicast address) that identifies a group of STAs and the way they may communicate with the AP using one or more specific antennas on the AP. The definition of the group ID may be signaled by a specific frame exchange that may be communicated during control and management procedures, such as association or other procedures. For example, during the allocations of the SPs and CBAPs in extended schedule elements by the AP 442, the address used (e.g., group ID) to define the STAs that can participate in a particular allocation would then also define the type of behavior (synchronized/unsynchronized, and what antennas on the AP side to connect to).

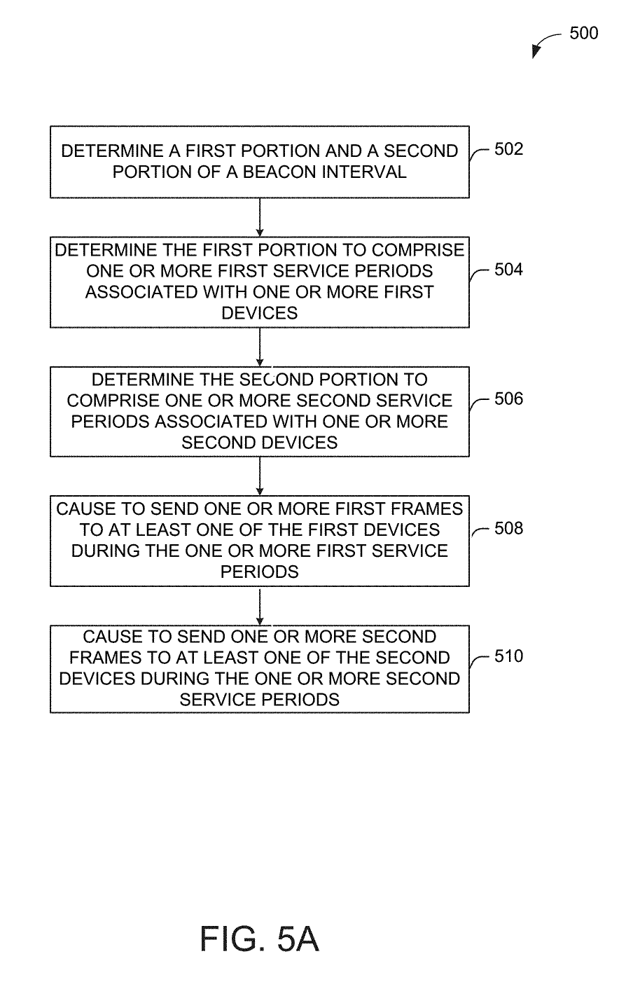

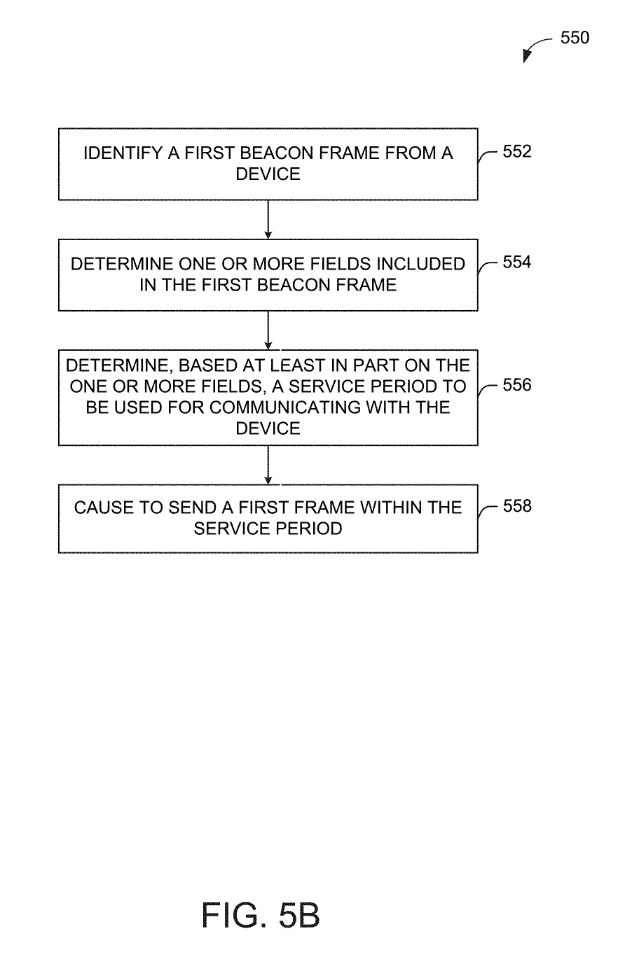

FIG. 5A depicts a flow diagram of an illustrative process for MU-MIMO synchronized and unsynchronized time periods allocation, in accordance with one or more example embodiments of the present disclosure.

At block 502, a device (e.g., the user device(s) 120 and/or the AP 102 of FIG. 1) may determine a first portion and a second portion of a beacon interval. A beacon interval is a time interval between two consecutive beacon frames. An AP may communicate with user devices in synchronized or unsynchronized MU-MIMO operations. In a synchronized MU-MIMO operation, the AP may simultaneously transmit to multiple devices in a frame that starts and ends at the same time. In an unsynchronized MU-MIMO operation, the AP may facilitate point-to-multipoint simultaneous transmissions between the AP and multiple devices, where each device is addressed separately by the AP. The AP may utilize beacon frames in order to determine whether a service period is allocated for a synchronized or unsynchronized operation. It should be noted that the beacon frames are sent during either a synchronized time period or an unsynchronized time period. The service periods may be assigned service periods or contention based access periods. The AP may encode or otherwise include in a beacon frame one or more fields that may include information associated with the one or more service periods. For example, the AP may utilize an extended schedule element in the beacon to include information associated with operations of one or more service periods. That is, the AP may utilize the extended schedule element to indicate whether a service period is associated with a synchronized operation or an unsynchronized operation. When a user device receives a beacon frame, it may decode or otherwise determine whether a service period is for a synchronized operation or for an unsynchronized operation. The extended schedule element may also include other information that may assist the user device in determining its communication with the AP. For example, the AP may define a user device behavior in a synchronized phase and in an unsynchronized phase.

At block 504, the device may determine the first portion to comprise one or more first service periods associated with one or more first devices. For example, the AP may associate a first portion of the beacon interval to be for a synchronized operation, such that the AP may utilize one or more antennas to communicate in a synchronized fashion with one or more user devices. The first portion of the beacon interval may be associated with one or more user devices. The AP may determine that communication with these one or more devices may be done in a synchronized fashion. Each portion of the beacon interval may contain one or more service periods that are either assigned service periods or contention based access periods that user devices may utilize. An assigned service or contention based access allocation within an extended schedule element may comprise one or more individual allocations associated with one or more user devices. A service period is a contiguous time period for which a user device is capable of data transfer. Within each beacon interval, one or more assigned service periods and/or one or more contention based access periods may be allocated by the AP. During the contention based access period, multiple user devices may contend for channel access in order to transmit their data.

At block 506, the device may determine the second portion to comprise one or more second service periods associated with one or more second devices. For example, the AP may associate the second portion of the beacon interval to be allocated for unsynchronized operations. The second portion may also include one or more assigned service periods and/or one or more contention based access periods. During those service periods, user devices may communicate with the AP in an unsynchronized fashion.

At block 508, the device may cause to send one or more first frames to at least one of the first devices during the one or more first service periods. For example, the AP may simultaneously communicate with one or more user devices that may be assigned one or more service periods that are dedicated for synchronized operation. In that case, the one or more user devices may communicate during the assigned service periods that are allocated for synchronized operations with the AP by sending and receiving data frames with the AP such that the data frames start in the same time. It should be understood that the AP may be simultaneously communicating with multiple user devices using multiple antennas.

At block 510, the device may cause to send one or more second frames to at least one of the second devices during the one or more second service periods. User devices that are allocated service periods for unsynchronized operations may communicate with the AP by sending and receiving data frames such that each user device is addressed separately by the AP. That is, the AP may send a first message to a first device and a second message to a second device such that the first message and the second message are unsynchronized in time. The AP may be simultaneously communicating with multiple user devices using multiple antennas.

FIG. 5B depicts a flow diagram of an illustrative process for MU-MIMO synchronized and unsynchronized time periods allocation, in accordance with one or more example embodiments of the present disclosure.

At block 552, a device (e.g., the user device(s) 120 and/or the AP 102 of FIG. 1) may identify a first beacon frame from a device. For example, a user device may receive a beacon frame from an AP. The beacon frame may include information that may assist the user device in determining how to communicate with the AP. The beacon frame may include at least in part, an extended schedule element that further includes information associated with service periods that may be allocated by the AP. The extended schedule element may also include other information that may assist the user device receiving the beacon frame in determining how to communicate with the AP. For example, the extended schedule element may include identification information of a specific antenna that the AP intends to use while communicating with that user device. Further, the extended schedule element may include what frames can be used while communicating during a service period. The extended schedule element may also indicate to the user device whether a service period is allocated for synchronized or unsynchronized operations. Other information may include what antenna to use for beamforming configuration and training.

At block 554, the device may determine one or more fields included in the first beacon frame. For example, a user device may receive the beacon frame and determine the extended schedule element from the beacon frame. The user device may decode the extended schedule element in order to extract information that may determine the behavior of the user device during a service period.

At block 556, the device may determine, based at least in part on the one or more fields, a service period to be used for communicating with the device. A service period may be allocated by the AP to be designated for synchronized or unsynchronized operations. For example, when the user device determines that a designated service period is for synchronized operation, the user device may then communicate with the AP based on information extracted from the extended schedule element.

At block 558, the device may cause to send a first frame within the service period. For example, the user device may send a frame to the AP based on information extracted from the extended schedule element. If for example the AP indicates in the beacon frame (or an announce frame) that a service period is allocated for synchronized operation, user devices receiving that beacon frame may communicate with the AP in a synchronized fashion. In that case, the user devices may communicate during the assigned service periods that are allocated for synchronized operations with the AP by sending and receiving data frames with the AP such that the data frames start in the same time. It is understood that the above descriptions are for purposes of illustration and are not meant to be limiting.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or MAC communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 1, 2, 3, 4, 5A and 5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, the alphanumeric input device 712, and the UI navigation device 714 may be a touch screen display. The machine 700 may additionally include a storage device (i.e., drive unit) 716, a signal generation device 718 (e.g., a speaker), an MU-MIMO synchronized and unsynchronized time periods allocation device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The MU-MIMO synchronized and unsynchronized time periods allocation device 719 may carry out or perform any of the operations and processes (e.g., the processes 500 and 550) described and shown above. For example, the MU-MIMO synchronized and unsynchronized time periods allocation device 719 may be configured to facilitate a mode of operation for an AP to define time phases for synchronized operation (where all antennas are synchronized) and time phases for unsynchronized operation. The MU-MIMO synchronized and unsynchronized time periods allocation device 719 may also allocate one or more devices to specific antennas, during unsynchronized phases.

In one embodiment, the MU-MIMO synchronized and unsynchronized time periods allocation device 719 may define the behavior of one or more devices in the different phases. For example, in the synchronized phase, the MU-MIMO synchronized and unsynchronized time periods allocation device 719 may define which frames may be sent, which antennas to use, what beamforming configuration to use, and how to do perform beamforming training. In the unsynchronized phase, the MU-MIMO synchronized and unsynchronized time periods allocation device 719 may define which frames may be sent, which AP antenna/sector ID to connect to, and which beamforming configurations to use, and how to perform beamforming training.

It is understood that the above functions are only a subset of what the MU-MIMO synchronized and unsynchronized time periods allocation device 719 may be configured to perform and that other functions included throughout this disclosure may also be performed by the MU-MIMO synchronized and unsynchronized time periods allocation device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 500 and 550) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions. The device may further include instructions to at least one processor configured to access the at least one memory, wherein the at least one processor is configured to execute the computer-executable instructions to determine a first portion and a second portion of a beacon interval. The device may further include instructions to determine the first portion to comprise one or more first service periods associated with one or more first devices. The device may further include instructions to determine the second portion to comprise one or more second service periods associated with one or more second devices. The device may further include instructions to cause to send one or more first frames to at least one of the first devices during the one or more first service periods. The device may further include instructions to cause to send one or more second frames to at least one of the second devices during the one or more second service periods.

The implementations may include one or more of the following features. The one or more first service periods are associated with a synchronized operation between the device and the one or more first devices. The one or more second service periods are associated with an unsynchronized operation between the device and the one or more second devices. The one or more first service periods and the one or more second service periods include at least in part one or more assigned service periods or one or more contention based access periods. The beacon interval is a time interval between a first beacon frame and a second beacon frame. The first beacon frame may include at least in part an extended schedule element. The extended schedule element may include at least in part a first antenna identification of the device, a beamforming configuration, or a type of frames to be sent by at least one of the one or more first devices. The device may further include instructions to cause to send a first message to a first device of the one or more second devices. The device may further include instructions to cause to send a second message to a second device of the one or more second devices, wherein the first message and the second message are unsynchronized in time. The first message is sent on a first antenna of the device and the second message is sent on a second antenna of the device. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include identifying a first beacon frame from a device. The operations may include determining one or more fields included in the first beacon frame. The operations may include determining, based at least in part on the one or more fields, a service period to be used for communicating with the device. The operations may include causing to send a first frame within the service period.

The implementations may include one or more of the following features. The service period is at least one of a synchronized service period or an unsynchronized service period. The service period may include at least in part an assigned service period or a contention based access period (CBAP). The one or more fields include at least in part an extended schedule element. The extended schedule element may include at least in part a first antenna identification, a beamforming configuration, or a type of frames to be sent during the service period.

According to example embodiments of the disclosure, there may include a method. The method may include determining, by at least one processor, a first portion and a second portion of a beacon interval. The method may include determining the first portion to comprise one or more first service periods associated with one or more first devices. The method may include determining the second portion to comprise one or more second service periods associated with one or more second devices. The method may include causing to send one or more first frames to at least one of the first devices during the one or more first service periods. The method may include causing to send one or more second frames to at least one of the second devices during the one or more second service periods.

The implementations may include one or more of the following features. The one or more first service periods are associated with a synchronized operation between the device and the one or more first devices. The one or more second service periods are associated with an unsynchronized operation between the device and the one or more second devices. The one or more first service periods and the one or more second service periods include at least in part one or more assigned service periods or one or more contention based access periods. The beacon interval is a time interval between a first beacon frame and a second beacon frame. The first beacon frame includes at least in part an extended schedule element. The extended schedule element includes at least in part a first antenna identification of the device, a beamforming configuration, or a type of frames to be sent by at least one of the one or more first devices. The method may further include sending a first message to a first device of the one or more second devices. The method may further include sending a second message to a second device of the one or more second devices, wherein the first message and the second message are unsynchronized in time. The first message is sent on a first antenna of the device and the second message is sent on a second antenna of the device.

In example embodiments of the disclosure, there may be an apparatus. The apparatus may include means for determining a first portion and a second portion of a beacon interval. The apparatus may include means for determining the first portion to comprise one or more first service periods associated with one or more first devices. The apparatus may include means for determining the second portion to comprise one or more second service periods associated with one or more second devices. The apparatus may include means for causing to send one or more first frames to at least one of the first devices during the one or more first service periods. The apparatus may include means for causing to send one or more second frames to at least one of the second devices during the one or more second service periods.

The implementations may include one or more of the following features. The one or more first service periods are associated with a synchronized operation between the device and the one or more first devices. The one or more second service periods are associated with an unsynchronized operation between the device and the one or more second devices. The one or more first service periods and the one or more second service periods include at least in part one or more assigned service periods or one or more contention based access periods. The beacon interval is a time interval between a first beacon frame and a second beacon frame. The first beacon frame includes at least in part an extended schedule element. The extended schedule element includes at least in part a first antenna identification of the device, a beamforming configuration, or a type of frames to be sent by at least one of the one or more first devices. The apparatus may further include means for sending a first message to a first device of the one or more second devices. The apparatus may further include means for sending a second message to a second device of the one or more second devices, wherein the first message and the second message are unsynchronized in time. The first message is sent on a first antenna of the device and the second message is sent on a second antenna of the device.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least
one processor is configured to execute the computer-executable instructions to:
determine a first portion and a second portion of a beacon interval;
determine the first portion to comprise one or more first service periods associated with one or more first devices;
determine the second portion to comprise one or more second service periods associated with one or more second devices;
cause to send one or more first frames to at least one of the first devices during the one or more first service periods; and
cause to send one or more second frames to at least one of the second devices during the one or more second service periods.

2. The device of claim 1, wherein the one or more first service periods are associated with a synchronized operation between the device and the one or more first devices.

3. The device of claim 1, wherein the one or more second service periods are associated with an unsynchronized operation between the device and the one or more second devices.

4. The device of claim 1, wherein the one or more first service periods and the one or more second service periods include at least in part one or more assigned service periods or one or more contention based access periods.

5. The device of claim 1, wherein the beacon interval is a time interval between a first beacon frame and a second beacon frame.

6. The device of claim 5, wherein the first beacon frame includes at least in part an extended schedule element.

7. The device of claim 6, wherein the extended schedule element includes at least in part a first antenna identification of the device, a beamforming configuration, or a type of frames to be sent by at least one of the one or more first devices.

8. The device of claim 1, wherein the at least one processor is further configured to execute the computer-executable instructions to:
cause to send a first message to a first device of the one or more second devices; and
cause to send a second message to a second device of the one or more second devices, wherein the first message and the second message are unsynchronized in time.

9. The device of claim 8, wherein the first message is sent on a first antenna of the device and the second message is sent on a second antenna of the device.

10. The device of claim 1, further comprising a transceiver configured to transmit and receive wireless signals.

11. The device of claim 10, further comprising one or more antennas coupled to the transceiver.

12. A non-transitory computer-readable medium storing computer-executable instructions which when executed by one or more processors result in performing operations comprising:
identifying a first beacon frame from a device;
determining one or more fields included in the first beacon frame;
determining, based at least in part on the one or more fields, a service period to be used for communicating with the device; and
causing to send a first frame within the service period.

13. The non-transitory computer-readable medium of claim 12, wherein the service period is at least one of a synchronized service period or an unsynchronized service period.

14. The non-transitory computer-readable medium of claim 12, wherein the service period includes at least in part an assigned service period or a contention based access period (CBAP).

15. The non-transitory computer-readable medium of claim 12, wherein the one or more fields include at least in part an extended schedule element.

16. The non-transitory computer-readable medium of claim 15, wherein the extended schedule element includes at least in part a first antenna identification, a beamforming configuration, or a type of frames to be sent during the service period.

17. A method comprising:
determining, by at least one processor, a first portion and a second portion of a beacon interval;
determining the first portion to comprise one or more first service periods associated with one or more first devices;
determining the second portion to comprise one or more second service periods associated with one or more second devices;
causing to send one or more first frames to at least one of the first devices during the one or more first service periods; and
causing to send one or more second frames to at least one of the second devices during the one or more second service periods.

18. The method of claim 17, wherein the one or more first service periods are associated with a synchronized operation between the device and the one or more first devices.

19. The method of claim 17, wherein the one or more second service periods are associated with an unsynchronized operation between the device and the one or more second devices.

20. The method of claim 17, wherein the one or more first service periods and the one or more second service periods include at least in part one or more assigned service periods or one or more contention based access periods.
